(19) United States
(12) Patent Application Publication
(10) Pub. No.: US 2026/0064199 A1
(43) Pub. Date: Mar. 5, 2026

(54) MINIATURIZED FRINGE PROJECTORS

(71) Applicant: Meta Platforms Technologies, LLC, Menlo Park, CA (US)

(72) Inventors: Alexandra Gualdino, San Francisco, CA (US); Hod Finkelstein, Oakland, CA (US); Chandra Sekhar Kakani, Fremont, CA (US); Ajit Vijay Barve, Los Gatos, CA (US)

(21) Appl. No.: 19/312,221

(22) Filed: Aug. 27, 2025

Related U.S. Application Data
(60) Provisional application No. 63/687,658, filed on Aug. 27, 2024.

(51) Int. Cl. G06F 3/01; G02B 27/00; G02B 27/01

(52) U.S. Cl. CPC G06F 3/013; G02B 27/0093; G02B 27/017; G02B 2027/0178

(57) ABSTRACT

An example method described herein is performed at an illumination system for performing eye-tracking at an AR device. The illumination system includes laser sources, waveguides, phase tuning elements, and emission apertures. The method includes causing emission, via a respective laser source of the one or more laser sources, of laser light. The method includes receiving, via the one or more waveguides, the laser light from the respective laser source, such that the laser light is propagated along a first optical path and a second optical path. The method includes adjusting, via the phase-tuning element, the phase in the first optical path, such that a phase in the first optical path is different than another phase in the second optical path. And the method includes outputting, via at least the first and second emission apertures, respective laser light from the first and second optical paths, to form a fringe illumination pattern.

### RELATED APPLICATION

This application claims priority to U.S. Provisional Application Serial No. 63/687,658, filed August 27, 2024, entitled “Miniaturized Fringe Projectors,” which is incorporated herein by reference.

### TECHNICAL FIELD

This relates generally to projectors for illuminating patterns from a light source, and specifically an illumination system for performing eye tracking at an AR device that includes miniaturized fringe projectors.

### BACKGROUND

Using a projection system including waveguides to perform eye-tracking can be an effective way to determine where a user is directing their gaze (e.g., identifying a gaze direction). There are implementations of XR devices that would be benefitted by gaze tracking, since XR content is generally not limited to a relatively small rectangular display that fits within a portion of a user’s field of view. Common miniaturized illumination systems use vertical cavity surface-emitting lasers (VCSELs). But such gaze-tracking systems are bulky and can thus diminish the user experience of such XR devices, since reliance on optical elements to shape the VCSEL emission results in an increased size and imposes limits in miniaturization in applications where size is critical.

As such, there is a need to address one or more of the above-identified challenges. A brief summary of solutions to the issues noted above are described below.

### SUMMARY

The present application describes miniaturized fringe pattern illuminators can be achieved with vertical cavity emitting lasers which can be combined with optical elements to collimate and diffract and perform at small sizes. Further, the generation of customized illumination patterns is needed to support structured light-based machine vision systems.

Some embodiments herein describe dynamically adjustable illumination patterns which can enable higher accuracy object detection in such computer vision systems and support the use of advanced algorithms. Some embodiments describe smaller period fringe patterns can be used to improve near field sensing, which improves upon the more common line spacing that is enabled by more established miniaturized illumination systems that are commonly based on vertical cavity surface-emitting laser (VCSEL). Further, embodiments described herein address other drawbacks of existing systems. For example, current systems typically rely on optical elements to shape the VCSEL emission results in an increased size and imposes limits in miniaturization in applications where size is critical.

Smaller period fringe patterns can be used to improve near field sensing which go beyond the line spacing that is enabled by more established miniaturized illumination systems that are commonly based on VCSEL lasers. The proposed illuminator concept can enable more advanced eye tracking algorithms which improve the performance of such input systems. The resulting products will have smaller size and weight and as a result more can result in a more efficient and effective user experience. In some embodiments, the illumination pattern can be dynamically modulated by changing the optical characteristics of one of the emission sources.

An example method described herein is performed at an illumination system for performing eye-tracking at an AR device. The illumination system includes (i) one or more laser sources, (ii) one or more waveguides, (iii) one or more phase tuning elements, and (iv) a plurality of emission apertures including a first emission aperture and a second emission aperture. The example method includes causing emission, via a respective laser source of the one or more laser sources, of laser light. The example method includes receiving, via the one or more waveguides, the laser light from the respective laser source, such that the laser light is propagated along a first optical path and a second optical path. The example method includes adjusting, via the phase-tuning element, the phase in the first optical path, such that a respective phase in the first optical path is different than another respective phase in the second optical path. And the example method includes outputting, via at least the first and second emission apertures, respective laser light from the first and second optical paths, to form a fringe illumination pattern.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A and 1B illustrate a first example illumination system including a double-channel interference fringe projector for structured light, in accordance with some embodiments.

FIGS. 2A and 2B illustrate a second example illumination system including a multi-emitter edge emitting laser directed to a fringe projector for structured light, in accordance with some embodiments.

FIG. 3 shows an example method flow chart for using a miniaturized fringe projector to present AR content, in accordance with some embodiments.

FIGS. 4A, 4B, 4C-1, and 4C-2 illustrate example MR and AR systems, in accordance with some embodiments.

In accordance with customary practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with distinct types of extended-realities (XRs) such as mixed-reality (MR) and augmented-reality (AR) systems. MRs and ARs, as described herein, are any superimposed functionality and/or sensory-detectable presentation provided by MR and AR systems within a user’s physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user’s hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user’s hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user’s hand or another finger, on the user’s leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user’s possession (e.g., smartphones, laptops, imaging devices, intermediary devices, and/or other devices described herein).

The input modalities as alluded to above can be varied and are dependent on a user’s experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are distinct types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user’s heart rate; (v) peripheral oxygen saturation (SpO₂) sensors for measuring blood oxygen saturation and/or other biometric data of a user; (vi) capacitive sensors for detecting changes in potential at a portion of a user’s body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user’s environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Double Channel Interference Fringe Projector for Structured Light

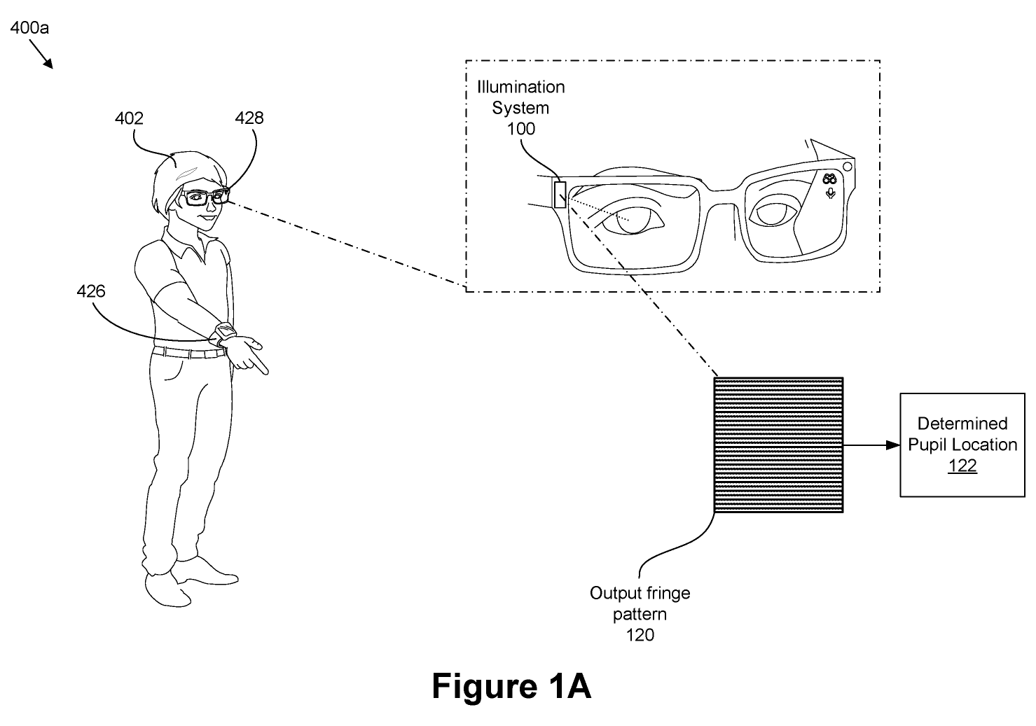

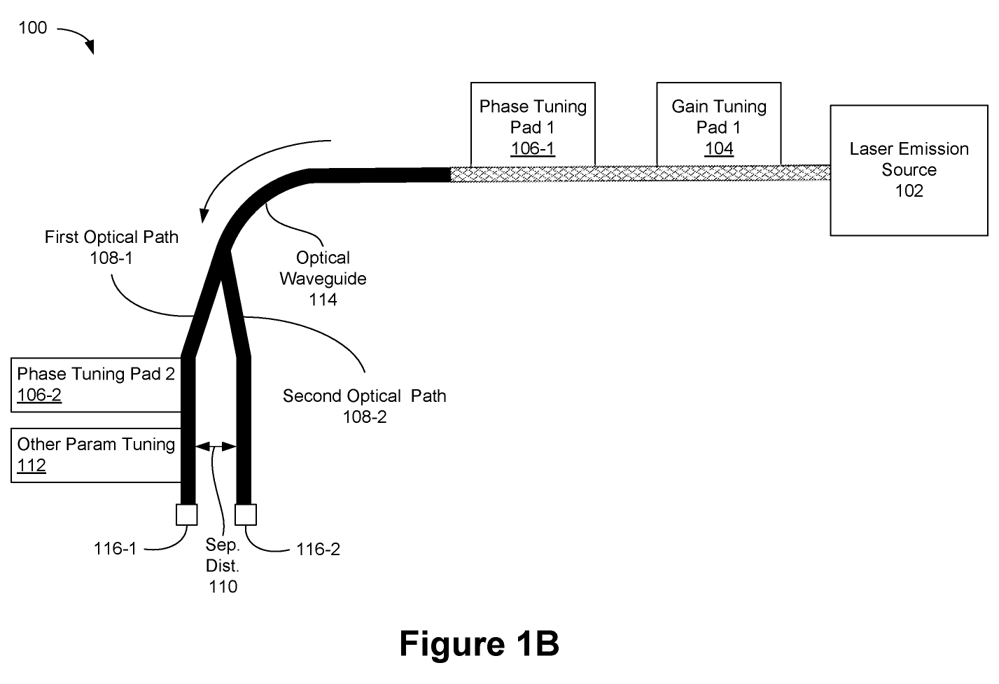

FIGS. 1A and 1B illustrate a first example illumination system including a double-channel interference fringe projector for structured light, in accordance with some embodiments.

FIG. 1A shows an AR system 400a that includes a user 402 that is wearing a wrist-wearable device 426 and an AR device 428, in accordance with some embodiments. In accordance with some embodiments, the AR device 428 includes an illumination system 100 that is configured to perform eye tracking with respect to the eye of the user 402, which may be used to facilitate interactions with AR content being presented by the AR device 428.

FIG. 1B depicts a details block diagram of the illumination system 100 that is integrated with the AR device 428 shown in FIG. 1A. In accordance with some embodiments, processors of the AR device and/or another electronic device in operable communication with the AR device 428 may be used to facilitate performance of the operations described herein. For example, the HIPD 442 may be used to offload some portion of the processing performed as part of the gaze tracking functions described herein.

The depiction of the illumination system 100 that is shown in FIG. 1B includes a portion of a double-channel interference fringe projector that includes a laser emission source 102 that is configured emit light across a first channel that includes a gain tuning pad 104 and a first phase tuning pad 106-1, in accordance with some embodiments.

In accordance with some embodiments, the light that is provided by the laser emission source 102 is provided to a waveguide (e.g., an optical waveguide 114) that optically splits into two different optical paths, including a first optical path 108-1, and a second optical path 108-2. After the light is received by the first optical path 108-1 and the second optical path 108-2, the light is provided to respective output emitters 116-1 and 116-2, where the light is output to be received as an interference pattern that can be used to determine an orientation of a user’s pupil (e.g., a pupil of the user 402).

In accordance with some embodiments, the position of the fringes of the illumination pattern can be dynamically adjusted by modification of the phase in one of the optical paths created by optically splitting the waveguide 114. For example, as shown in FIG. 1, the first optical path 108-1 is coupled to a second phase tuning pad 106-2, which can provide for additional phase tuning for the portion of the light that is provided to the first optical path 108-1. In some embodiments, the phase tuning pads 106-1 and 106-2 can include one or more of thermo-optical modulators, free carrier depletion-based phase shifters, and/or liquid crystals. In some embodiments, at least one of the optical paths includes a tuning component 112 for tuning a different parameter of the light traveling through the optical path (e.g., divergence)

In accordance with some embodiments, a period of fringes in one or more of the illumination patterns is lithographically defined by a separation distance 110 between the first optical path 108-1 and the second optical path 108-2. In some embodiments, each of the first optical path 108-1 and the second optical path 108-2 are part of a same semiconductor-based substrate. In some embodiments, the output direction of an illumination pattern from one or more of the first waveguide 108-1 or the second waveguide 108-2 is along the optical waveguide, or normal to the respective waveguide. In some embodiments one or more of a Bragg grating or another light bending structure of the illumination system 100.

### Multi-Emitter Edge Emitting Laser for Fringe Projector for Structured Light

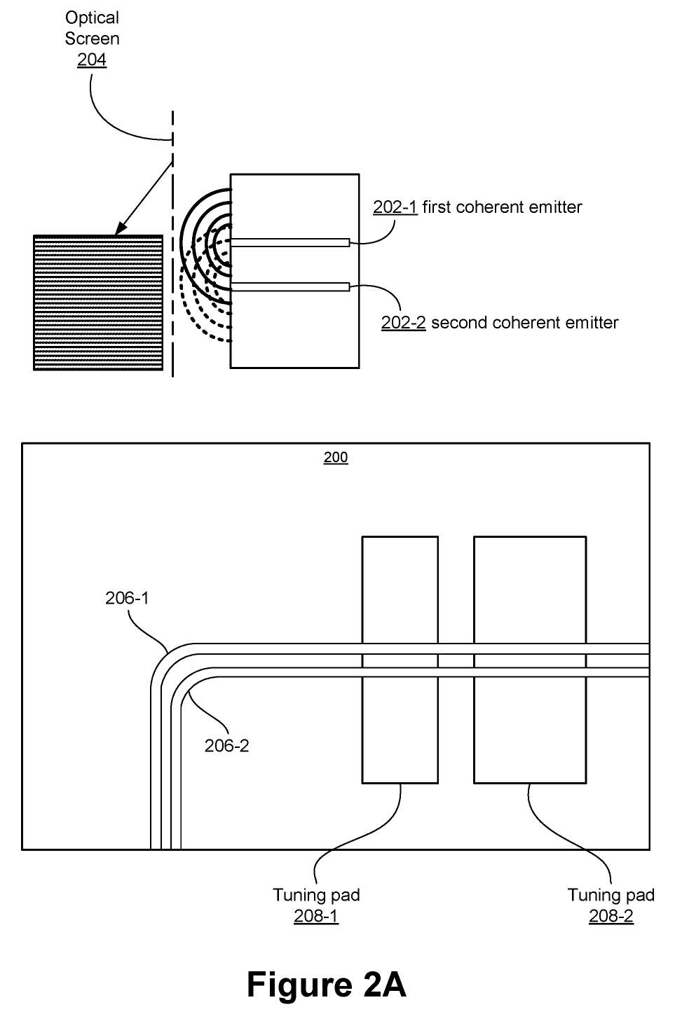

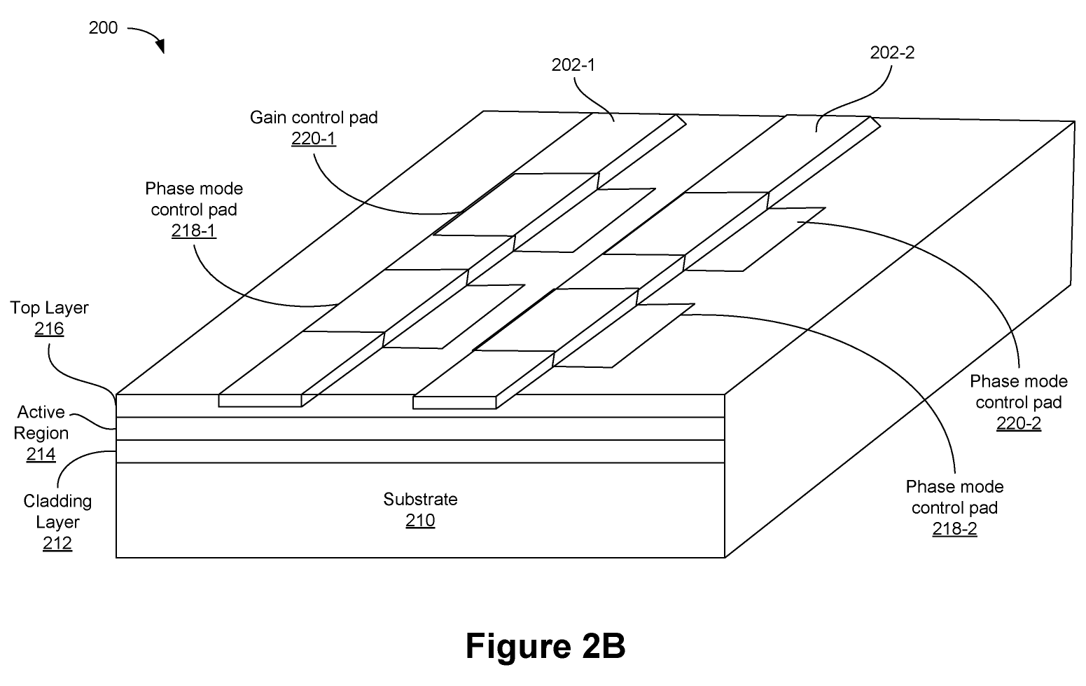

FIGS. 2A and 2B illustrate aspects of a second example illumination system 200, in accordance with some embodiments. In accordance with some embodiments, a second proposed approach includes using two lasers that can be independently tuned for a set of one or more independent and/or dependent parameters (e.g., gain and phase)-. This can be used (a) directly, without needing additional waveguides or (b) coupling to two additional waveguides to change optical parameters such as divergence.

FIG. 2A shows an embodiment of the application that includes two lasers (e.g., a first coherent emitter 202-1, a second coherent emitter 202-2) that are each configured to cause light to be emitted into the respective waveguides 206-1 and 206-2. In accordance with some embodiments, the light from the emitters is projected towards an optical screen 204.

As shown in FIG. 2A, each of the waveguides 206-1 and 206-2, and/or each of the respective light sources (e.g., the first coherent emitter 202-1, the second coherent emitter 202-2) can be coupled to two different tuning pads (e.g., a first tuning pad 208-1 and a second tuning pad 208-2), which can allow for independent tuning of each of the light sources and/or waveguides cause differentiation between the respective fringe patterns output from each of the respective waveguides 206-1 and 206-2.

FIG. 2B depicts a three-dimensional cross section of a substrate 210 that includes the first coherent emitter 202-1 and the second coherent emitter 202-2. As shown in FIG. 2B, the substrate is covered with a cladding layer 212 and an active region 214, as well as a top layer 216. In accordance with some embodiments, each of the first and second coherent emitters 202-1 and 202-2 is coupled to respective phase control pads 218-1 and 218-2, and gain control pads 220-1, which can allow for independent adjustment of each of the light sources.

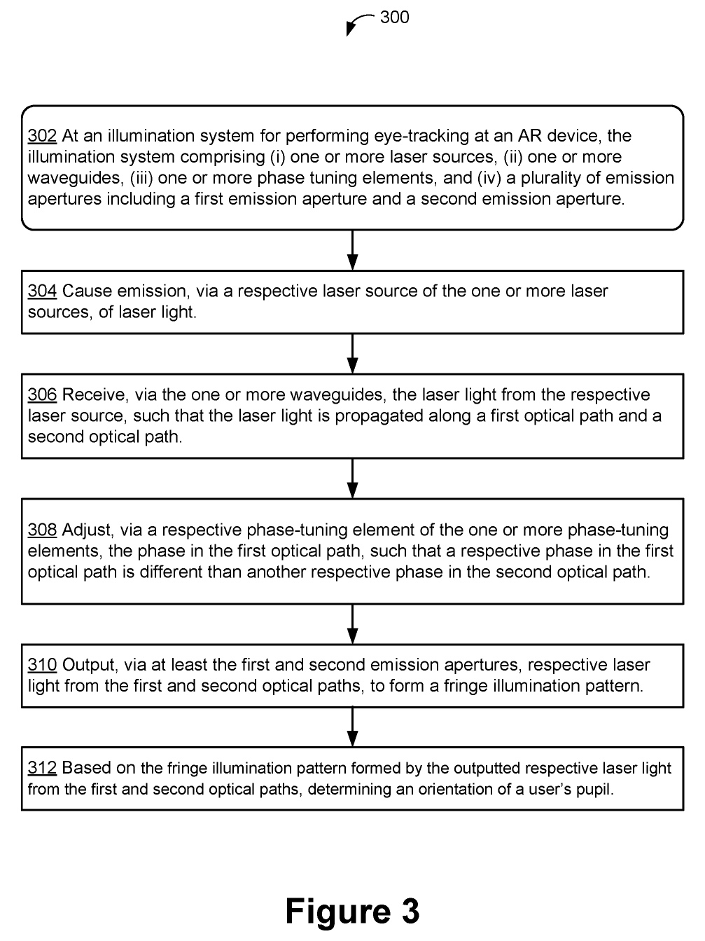

FIG. 3 shows an example method flow chart for a method 300 of using a miniaturized fringe projector to present AR content, in accordance with some embodiments. Operations (e.g., steps) of the method 300 can be performed by one or more processors (e.g., central processing unit and/or MCU) of a system, such as the XR system 300a. At least some of the operations shown in FIG. 3 correspond to instructions stored in a computer memory or computer-readable storage medium (e.g., storage, RAM, and/or memory) (e.g., of the VR device 332 in .

Operations of the method 300 can be performed by a single device alone or in conjunction with one or more processors and/or hardware components of another communicatively coupled device (e.g., the AR device 328, the VR device 332) and/or instructions stored in memory or computer-readable medium of the other device communicatively coupled to the XR system 300a. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(A1) In accordance with some embodiments described herein, the method 300 is performed at an illumination system for performing eye-tracking at an AR device, the illumination system comprising (i) one or more laser sources, (ii) one or more waveguides, (iii) one or more phase tuning elements, and (iv) a plurality of emission apertures including a first emission aperture and a second emission aperture.

The method 300 includes causing (304) emission, via a respective laser source of the one or more laser sources, of laser light. For example, FIG. 1 shows a laser emission source 102 directing light to the waveguide 114.

The method 300 includes receiving (306), via the one or more waveguides, the laser light from the respective laser source, such that the laser light is propagated along a first optical path and a second optical path. For example, FIG. 1 shows the waveguide 114 being optically split to form the first optical path 108-1 and the second optical path 108-2.

The method 300 includes adjusting (308), via a respective phase-tuning element of the one or more phase-tuning elements, the phase in the first optical path, such that a respective phase in the first optical path is different than another respective phase in the second optical path.

The method 300 includes outputting (310), via at least the first and second emission apertures, respective laser light from the first and second optical paths, to form a fringe illumination pattern.

The method 300 includes based on the fringe illumination pattern formed by the outputted respective laser light from the first and second optical paths, determining (312) an orientation of a user’s pupil. For example, FIG. 1A shows that the illumination system 100 determines the pupil location of the user (step 122) based on the output fringe pattern 120.

(A2) In some embodiments of A1, the one or more laser sources comprises a first laser source and a second laser source. In some embodiments, the one or more waveguides includes a first waveguide configured to receive first light from the first laser source, and a second waveguide configured to receive second light from the second laser source. In some embodiments, each of the first waveguide and the second waveguide are coupled to a different respective phase-tuning element, including the respective phase-tuning element and another phase-tuning element that is distinct and separate from the phase-tuning element.

(A3) In some embodiments of A2, the first laser source and the second laser source are formed in a same semiconductor substrate.

(A4) In some embodiments of A2 or A3, the same semi-conductor substrate includes a cladding layer, an active region, and a top layer. In some embodiments, each of the first and second laser sources are embedded into separate locations of the top layer of the same semi-conductor substrate. In some embodiments, the first laser source is coupled to a first gain-tuning element, and a first phase-tuning element. In some embodiments, the second laser source is coupled to a second gain-tuning element separate from the first gain-tuning element and a second phase-tuning element separate from the first phase-tuning element, such that the second laser source is independently tunable in both gain and phase from the first laser source.

(A5) In some embodiments of A4, at least one of the first waveguide and the second waveguide are configured to adjust at least one other parameter of the first and second laser sources besides phase or gain (e.g., divergence).

(A6) In some embodiments of any one of A1 to A5, the phase tuning phase tuning element includes at least one of a thermo-optical modulator, one or more free carrier depletion based base shifters, or liquid crystals.

(A7) In some embodiments of A6, a period of fringes in the fringe illumination pattern is defined by a distance between the first optical path and the second optical path of the first optical waveguide.

(A8) In some embodiments of any one of A1 to A7, the phase tuning element includes at least one of a thermo-optical modulator, one or more free carrier depletion based base shifters, or liquid crystals.

(B1) In some embodiments, another example method of using an illumination system for eye-tracking is provided. The illumination system includes a laser source configured to emit laser light. The illumination system includes a waveguide configured to receive the laser light from the laser source, wherein the waveguide is optically split into a first optical path and a second optical path. The illumination systems includes a phase tuning element configured to adjust the phase in the first optical path to generate phase-modulated laser light exiting a first emission aperture of the first optical path, and wherein a second emission aperture of the second optical path is configured to output the laser light to form a fringe illumination pattern.

(B2) In some embodiments of B1, the phase tuning element includes at least one of a thermo-optical modulator, free carrier depletion based base shifters, or liquid crystals.

(C1) In some embodiments, another example method of using an illumination system for eye-tracking is provided. The illumination system includes a first laser source configured to emit first laser light. The illumination system includes a first phase modulator configured to modulate a first phase of the first laser light. The illumination system includes a second laser source configured to emit second laser light. The illumination system includes a second phase modulator configured to modulate a second phase of the second laser light, wherein a first emission aperture outputting the first laser light is spaced from a second emission aperture outputting the second laser light to generate a fringe illumination pattern.

(C2) In some embodiments of C1, the first laser source and the second laser source are formed in a same semiconductor substrate.

(D1) In accordance with some embodiments, a system that includes a wrist wearable device (or a plurality of wrist-wearable devices) and a pair of augmented-reality glasses, and the system is configured to perform operations corresponding to any of A1 to A8, B1 or B2, or C1 or C2.

(E1) In accordance with some embodiments, a non-transitory computer readable storage medium including instructions that, when executed by a computing device in communication with a pair of augmented-reality glasses, cause the computer device to perform operations corresponding to any of A1 to A8, B1 or B2, or C1 or C2.

(F1) In accordance with some embodiments, a method of operating a pair of augmented-reality glasses, including operations that correspond to any of A1 to A8, B1 or B2, or C1 or C2.

### Example Extended-Reality Systems

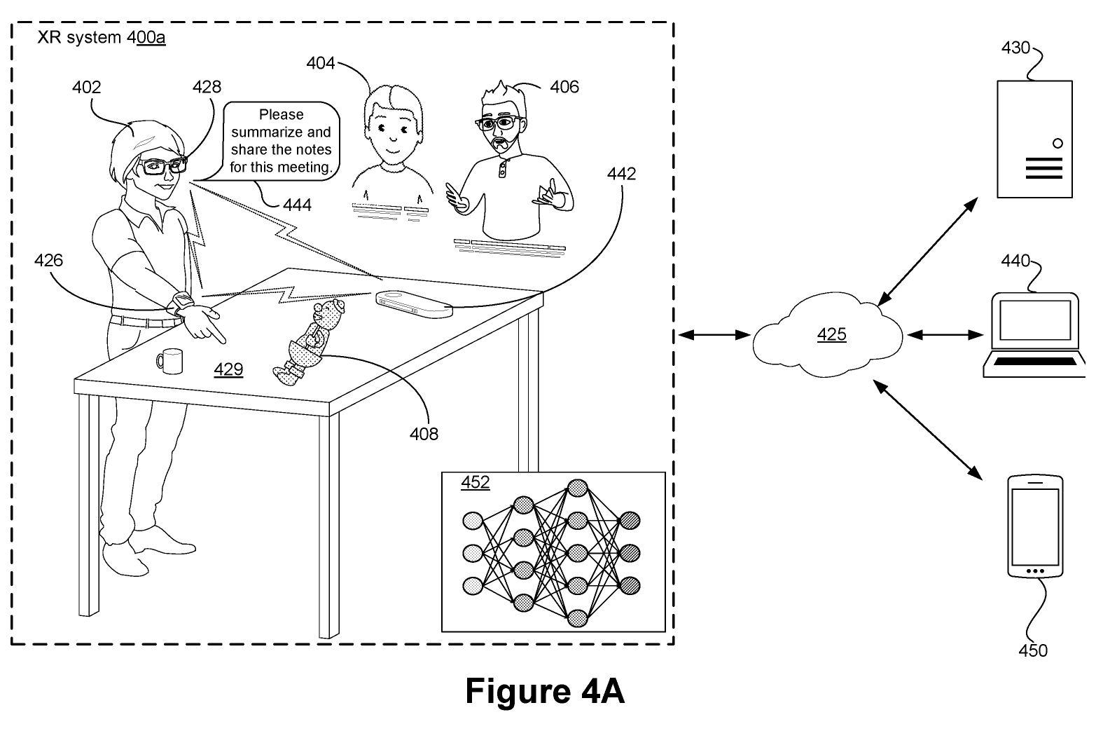

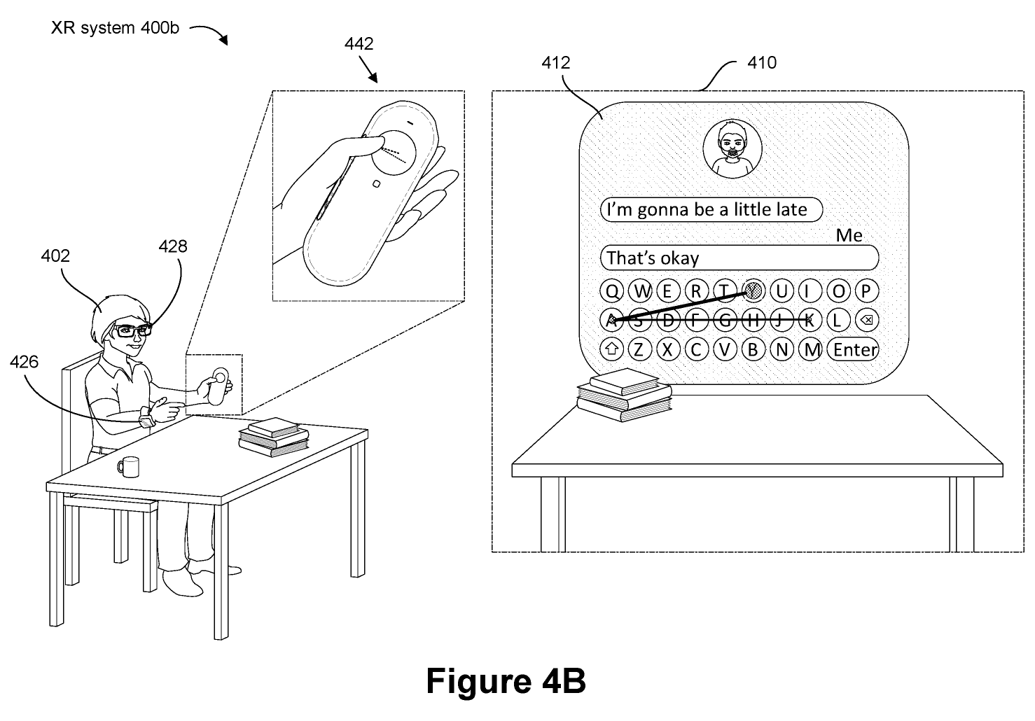

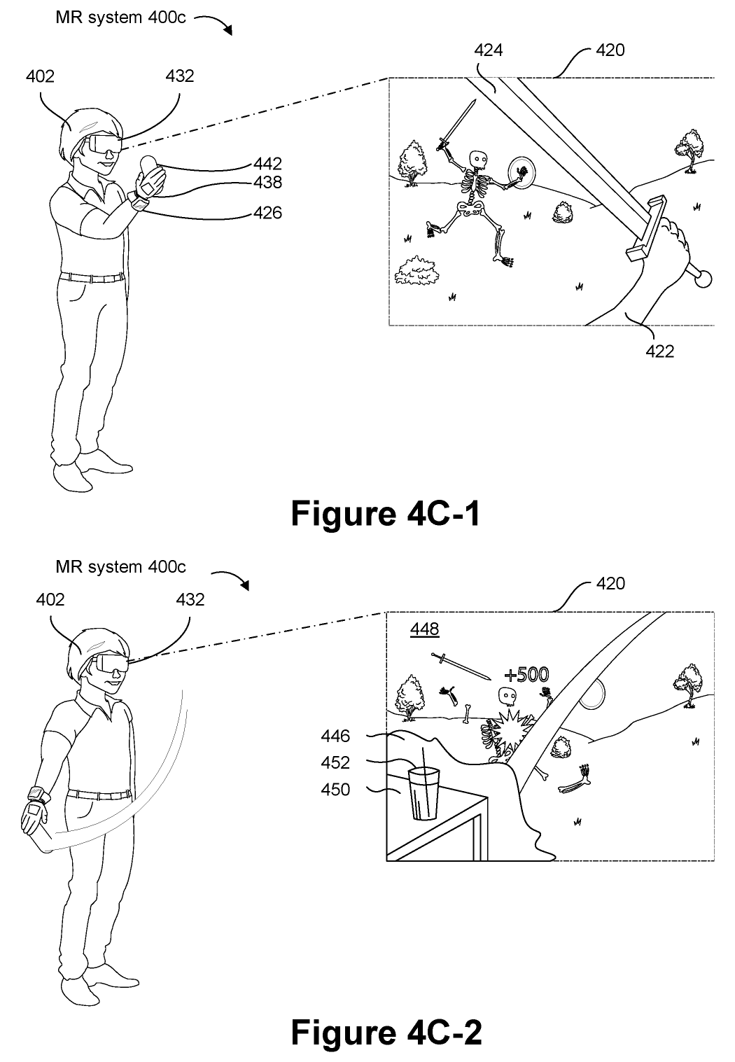

FIGS. 4A, 4B, 4C-1, and 4C-2, illustrate example XR systems that include AR and MR systems, in accordance with some embodiments. FIG. 4A shows a first AR system 400a and first example user interactions using a wrist-wearable device 426, a head-wearable device (e.g., AR device 428), and/or a HIPD 442. FIG. 4B shows a second AR system 400b and second example user interactions using a wrist-wearable device 426, AR device 428, and/or an HIPD 442. FIGS. 4C-1 and 4C-2 show a third MR system 400c and third example user interactions using a wrist-wearable device 426, a head-wearable device (e.g., an MR device such as a VR device), and/or an HIPD 442. As the skilled artisan will appreciate upon reading the descriptions provided herein, the above-example AR and MR systems (described in detail below) can perform various functions and/or operations.

The wrist-wearable device 426, the head-wearable devices, and/or the HIPD 442 can communicatively couple via a network 425 (e.g., cellular, near field, Wi-Fi, personal area network, wireless LAN). Additionally, the wrist-wearable device 426, the head-wearable device, and/or the HIPD 442 can also communicatively couple with one or more servers 430, computers 440 (e.g., laptops, computers), mobile devices 450 (e.g., smartphones, tablets), and/or other electronic devices via the network 425 (e.g., cellular, near field, Wi-Fi, personal area network, wireless LAN). Similarly, a smart textile-based garment, when used, can also communicatively couple with the wrist-wearable device 426, the head-wearable device(s), the HIPD 442, the one or more servers 430, the computers 440, the mobile devices 450, and/or other electronic devices via the network 425 to provide inputs.

Turning to FIG. 4A, a user 402 is shown wearing the wrist-wearable device 426 and the AR device 428 and having the HIPD 442 on their desk. The wrist-wearable device 426, the AR device 428, and the HIPD 442 facilitate user interaction with an AR environment. In particular, as shown by the first AR system 400a, the wrist-wearable device 426, the AR device 428, and/or the HIPD 442 cause presentation of one or more avatars 404, digital representations of contacts 406, and virtual objects 408. As discussed below, the user 402 can interact with the one or more avatars 404, digital representations of the contacts 406, and virtual objects 408 via the wrist-wearable device 426, the AR device 428, and/or the HIPD 442. In addition, the user 402 is also able to directly view physical objects in the environment, such as a physical table (e.g., table 429), through transparent lens(es) and waveguide(s) of the AR device 428. Alternatively, an MR device could be used in place of the AR device 428 and a similar user experience can take place, but the user would not be directly viewing physical objects in the environment, such as table 429, and would instead be presented with a virtual reconstruction of the table 429 produced from one or more sensors of the MR device (e.g., an outward facing camera capable of recording the surrounding environment).

The user 402 can use any of the wrist-wearable device 426, the AR device 428 (e.g., through physical inputs at the AR device and/or built-in motion tracking of a user’s extremities), a smart-textile garment, externally mounted extremity tracking device, the HIPD 442 to provide user inputs, etc. For example, the user 402 can perform one or more hand gestures that are detected by the wrist-wearable device 426 (e.g., using one or more EMG sensors and/or IMUs built into the wrist-wearable device) and/or AR device 428 (e.g., using one or more image sensors or cameras) to provide a user input. Alternatively, or additionally, the user 402 can provide a user input via one or more touch surfaces of the wrist-wearable device 426, the AR device 428, and/or the HIPD 442, and/or voice commands captured by a microphone of the wrist-wearable device 426, the AR device 428, and/or the HIPD 442. The wrist-wearable device 426, the AR device 428, and/or the HIPD 442 include an artificially intelligent digital assistant to help the user in providing a user input (e.g., completing a sequence of operations, suggesting different operations or commands, providing reminders, confirming a command). For example, the digital assistant can be invoked through an input occurring at the AR device 428 (e.g., via an input at a temple arm of the AR device 428). In some embodiments, the user 402 can provide a user input via one or more facial gestures and/or facial expressions. For example, cameras of the wrist-wearable device 426, the AR device 428, and/or the HIPD 442 can track the user 402’s eyes for navigating a user interface.

The wrist-wearable device 426, the AR device 428, and/or the HIPD 442 can operate alone or in conjunction to allow the user 402 to interact with the AR environment. In some embodiments, the HIPD 442 is configured to operate as a central hub or control center for the wrist-wearable device 426, the AR device 428, and/or another communicatively coupled device. For example, the user 402 can provide an input to interact with the AR environment at any of the wrist-wearable device 426, the AR device 428, and/or the HIPD 442, and the HIPD 442 can identify one or more back-end and front-end tasks to cause the performance of the requested interaction and distribute instructions to cause the performance of the one or more back-end and front-end tasks at the wrist-wearable device 426, the AR device 428, and/or the HIPD 442. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 442 can perform the back-end tasks and provide the wrist-wearable device 426 and/or the AR device 428 operational data corresponding to the performed back-end tasks such that the wrist-wearable device 426 and/or the AR device 428 can perform the front-end tasks. In this way, the HIPD 442, which has more computational resources and greater thermal headroom than the wrist-wearable device 426 and/or the AR device 428, performs computationally intensive tasks and reduces the computer resource utilization and/or power usage of the wrist-wearable device 426 and/or the AR device 428.

In the example shown by the first AR system 400a, the HIPD 442 identifies one or more back-end tasks and front-end tasks associated with a user request to initiate an AR video call with one or more other users (represented by the avatar 404 and the digital representation of the contact 406) and distributes instructions to cause the performance of the one or more back-end tasks and front-end tasks. In particular, the HIPD 442 performs back-end tasks for processing and/or rendering image data (and other data) associated with the AR video call and provides operational data associated with the performed back-end tasks to the AR device 428 such that the AR device 428 performs front-end tasks for presenting the AR video call (e.g., presenting the avatar 404 and the digital representation of the contact 406).

In some embodiments, the HIPD 442 can operate as a focal or anchor point for causing the presentation of information. This allows the user 402 to be generally aware of where information is presented. For example, as shown in the first AR system 400a, the avatar 404 and the digital representation of the contact 406 are presented above the HIPD 442. In particular, the HIPD 442 and the AR device 428 operate in conjunction to determine a location for presenting the avatar 404 and the digital representation of the contact 406. In some embodiments, information can be presented within a predetermined distance from the HIPD 442 (e.g., within five meters). For example, as shown in the first AR system 400a, virtual object 408 is presented on the desk some distance from the HIPD 442. Similar to the above example, the HIPD 442 and the AR device 428 can operate in conjunction to determine a location for presenting the virtual object 408. Alternatively, in some embodiments, presentation of information is not bound by the HIPD 442. More specifically, the avatar 404, the digital representation of the contact 406, and the virtual object 408 do not have to be presented within a predetermined distance of the HIPD 442. While an AR device 428 is described working with an HIPD, an MR headset can be interacted with in the same way as the AR device 428.

User inputs provided at the wrist-wearable device 426, the AR device 428, and/or the HIPD 442 are coordinated such that the user can use any device to initiate, continue, and/or complete an operation. For example, the user 402 can provide a user input to the AR device 428 to cause the AR device 428 to present the virtual object 408 and, while the virtual object 408 is presented by the AR device 428, the user 402 can provide one or more hand gestures via the wrist-wearable device 426 to interact and/or manipulate the virtual object 408. While an AR device 428 is described working with a wrist-wearable device 426, an MR headset can be interacted with in the same way as the AR device 428.

### Integration of Artificial Intelligence with XR Systems

FIG. 4A illustrates an interaction in which an artificially intelligent virtual assistant can assist in requests made by a user 402. The AI virtual assistant can be used to complete open-ended requests made through natural language inputs by a user 402. For example, in FIG. 4A the user 402 makes an audible request 444 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 4A also illustrates an example neural network 452 used in Artificial Intelligence applications. Uses of Artificial Intelligence (AI) are varied and encompass many distinct aspects of the devices and systems described herein. AI capabilities cover a diverse range of applications and deepen interactions between the user 402 and user devices (e.g., the AR device 428, an MR device 432, the HIPD 442, the wrist-wearable device 426). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein, that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user’s request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 402 can interact with an AI model through natural language inputs captured by a voice sensor, text inputs, or any other input modality that accepts natural language and/or a corresponding voice sensor module. In another instance, input is provided by tracking the eye gaze of a user 402 via a gaze tracker module. Additionally, the AI model can also receive inputs beyond those supplied by a user 402. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors’ data can be retrieved entirely from a single device (e.g., AR device 428) or from multiple devices that are in communication with each other (e.g., a system that includes at least two of an AR device 428, an MR device 432, the HIPD 442, the wrist-wearable device 426, etc.). The AI model can also access additional information (e.g., one or more servers 430, the computers 440, the mobile devices 450, and/or other electronic devices) via a network 425.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 428, an MR device 432, the HIPD 442, the wrist-wearable device 426) via the one or more networks. The cloud-computing platforms provide scalable computing resources, distributed computing, managed AI services, interference acceleration, pre-trained models, APIs, and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 428, an MR device 432, the HIPD 442, the wrist-wearable device 426), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 442), haptic feedback can provide information to the user 402. An AI model can also use the inputs described above to determine the appropriate modality and device(s) to present content to the user (e.g., a user walking on a busy road can be presented with an audio output instead of a visual output to avoid distracting the user 402).

### Example Augmented Reality Interaction

FIG. 4B shows the user 402 wearing the wrist-wearable device 426 and the AR device 428 and holding the HIPD 442. In the second AR system 400b, the wrist-wearable device 426, the AR device 428, and/or the HIPD 442 are used to receive and/or provide one or more messages to a contact of the user 402. In particular, the wrist-wearable device 426, the AR device 428, and/or the HIPD 442 detect and coordinate one or more user inputs to initiate a messaging application and prepare a response to a received message via the messaging application.

In some embodiments, the user 402 initiates, via a user input, an application on the wrist-wearable device 426, the AR device 428, and/or the HIPD 442 that causes the application to initiate on at least one device. For example, in the second AR system 400b the user 402 performs a hand gesture associated with a command for initiating a messaging application (represented by messaging user interface 412); the wrist-wearable device 426 detects the hand gesture; and, based on a determination that the user 402 is wearing the AR device 428, causes the AR device 428 to present a messaging user interface 412 of the messaging application. The AR device 428 can present the messaging user interface 412 to the user 402 via its display (e.g., as shown by user 402’s field of view 410). In some embodiments, the application is initiated and can be run on the device (e.g., the wrist-wearable device 426, the AR device 428, and/or the HIPD 442) that detects the user input to initiate the application, and the device provides another device operational data to cause the presentation of the messaging application. For example, the wrist-wearable device 426 can detect the user input to initiate a messaging application, initiate and run the messaging application, and provide operational data to the AR device 428 and/or the HIPD 442 to cause presentation of the messaging application. Alternatively, the application can be initiated and run at a device other than the device that detected the user input. For example, the wrist-wearable device 426 can detect the hand gesture associated with initiating the messaging application and cause the HIPD 442 to run the messaging application and coordinate the presentation of the messaging application.

Further, the user 402 can provide a user input provided at the wrist-wearable device 426, the AR device 428, and/or the HIPD 442 to continue and/or complete an operation initiated at another device. For example, after initiating the messaging application via the wrist-wearable device 426 and while the AR device 428 presents the messaging user interface 412, the user 402 can provide an input at the HIPD 442 to prepare a response (e.g., shown by the swipe gesture performed on the HIPD 442). The user 402’s gestures performed on the HIPD 442 can be provided and/or displayed on another device. For example, the user 402’s swipe gestures performed on the HIPD 442 are displayed on a virtual keyboard of the messaging user interface 412 displayed by the AR device 428.

In some embodiments, the wrist-wearable device 426, the AR device 428, the HIPD 442, and/or other communicatively coupled devices can present one or more notifications to the user 402. The notification can be an indication of a new message, an incoming call, an application update, a status update, etc. The user 402 can select the notification via the wrist-wearable device 426, the AR device 428, or the HIPD 442 and cause presentation of an application or operation associated with the notification on at least one device. For example, the user 402 can receive a notification that a message was received at the wrist-wearable device 426, the AR device 428, the HIPD 442, and/or other communicatively coupled device and provide a user input at the wrist-wearable device 426, the AR device 428, and/or the HIPD 442 to review the notification, and the device detecting the user input can cause an application associated with the notification to be initiated and/or presented at the wrist-wearable device 426, the AR device 428, and/or the HIPD 442.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 428 can present to the user 402 game application data and the HIPD 442 can use a controller to provide inputs to the game. Similarly, the user 402 can use the wrist-wearable device 426 to initiate a camera of the AR device 428, and the user can use the wrist-wearable device 426, the AR device 428, and/or the HIPD 442 to manipulate the image capture (e.g., zoom in or out, apply filters) and capture image data.

While an AR device 428 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user’s hand or other suitable surface (e.g., a table, whiteboard). In yet another embodiment, information may also be provided by locally dimming portions of a lens to emphasize portions of the environment in which the user’s attention should be directed. Some AR devices can present AR augments either monocularly or binocularly (e.g., an AR augment can be presented at only a single display associated with a single lens as opposed presenting an AR augmented at both lenses to produce a binocular image). In some instances, an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in an analogous manner to an MR headset, which is described below in the proceeding sections.

### Example Mixed Reality Interaction

Turning to FIGS. 4C-1 and 4C-2, the user 402 is shown wearing the wrist-wearable device 426 and an MR device 432 (e.g., a device capable of providing either an entirely VR experience or an MR experience that displays object(s) from a physical environment at a display of the device) and holding the HIPD 442. In the third AR system 400c, the wrist-wearable device 426, the MR device 432, and/or the HIPD 442 are used to interact within an MR environment, such as a VR game or other MR/VR application. While the MR device 432 presents a representation of a VR game (e.g., first MR game environment 420) to the user 402, the wrist-wearable device 426, the MR device 432, and/or the HIPD 442 detect and coordinate one or more user inputs to allow the user 402 to interact with the VR game.

In some embodiments, the user 402 can provide a user input via the wrist-wearable device 426, the MR device 432, and/or the HIPD 442 that causes an action in a corresponding MR environment. For example, the user 402 in the third MR system 400c (shown in FIG. 4C-1) raises the HIPD 442 to prepare for a swing in the first MR game environment 420. The MR device 432, responsive to the user 402 raising the HIPD 442, causes the MR representation of the user 422 to perform a similar action (e.g., raise a virtual object, such as a virtual sword 424). In some embodiments, each device uses respective sensor data and/or image data to detect the user input and provide an accurate representation of the user 402’s motion. For example, image sensors (e.g., SLAM cameras or other cameras) of the HIPD 442 can be used to detect a position of the HIPD 442 relative to the user 402’s body such that the virtual object can be positioned appropriately within the first MR game environment 420; sensor data from the wrist-wearable device 426 can be used to detect a velocity at which the user 402 raises the HIPD 442 such that the MR representation of the user 422 and the virtual sword 424 are synchronized with the user 402’s movements; and image sensors of the MR device 432 can be used to represent the user 402’s body, boundary conditions, or real-world objects within the first MR game environment 420.

In FIG. 4C-2, the user 402 performs a downward swing while holding the HIPD 442. The user 402’s downward swing is detected by the wrist-wearable device 426, the MR device 432, and/or the HIPD 442 and a corresponding action is performed in the first MR game environment 420. In some embodiments, the data captured by each device is used to improve the user’s experience within the MR environment. For example, sensor data of the wrist-wearable device 426 can be used to determine a speed and/or force at which the downward swing is performed and image sensors of the HIPD 442 and/or the MR device 432 can be used to determine a location of the swing and how it should be represented in the first MR game environment 420, which, in turn, can be used as inputs for the MR environment (e.g., game mechanics, which can use detected speed, force, locations, and/or aspects of the user 402’s actions to classify a user’s inputs (e.g., user performs a light strike, hard strike, critical strike, glancing strike, miss) or calculate an output (e.g., amount of damage)).

FIG. 4C-2 further illustrates that a portion of the physical environment is reconstructed and displayed at a display of the MR device 432 while the MR game environment 420 is being displayed. In this instance, a reconstruction of the physical environment 446 is displayed in place of a portion of the MR game environment 420 when object(s) in the physical environment are potentially in the path of the user (e.g., a collision with the user and an object in the physical environment are likely). Thus, this example MR game environment 420 includes (i) an immersive VR portion 448 (e.g., an environment that does not have a corollary counterpart in a nearby physical environment) and (ii) a reconstruction of the physical environment 446 (e.g., table 450 and a cup on the table). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 426, the MR device 432, and/or the HIPD 442 are described as detecting user inputs, in some embodiments, user inputs are detected at a single device (with the single device being responsible for distributing signals to the other devices for performing the user input). For example, the HIPD 442 can operate an application for generating the first MR game environment 420 and provide the MR device 432 with corresponding data for causing the presentation of the first MR game environment 420, as well as detect the user 402’s movements (while holding the HIPD 442) to cause the performance of corresponding actions within the first MR game environment 420. Additionally, or alternatively, in some embodiments, operational data (e.g., sensor data, image data, application data, device data, and/or other data) of one or more devices is provided to a single device (e.g., the HIPD 442) to process the operational data and cause respective devices to perform an action associated with processed operational data.

In some embodiments, the user 402 can wear a wrist-wearable device 426, wear an MR device 432, wear smart textile-based garments 438 (e.g., wearable haptic gloves), and/or hold an HIPD 442 device. In this embodiment, the wrist-wearable device 426, the MR device 432, and/or the smart textile-based garments 438 are used to interact within an MR environment (e.g., any AR or MR system described above in reference to FIGS. 4A–4B). While the MR device 432 presents a representation of an MR game (e.g., second MR game environment 420) to the user 402, the wrist-wearable device 426, the MR device 432, and/or the smart textile-based garments 438 detect and coordinate one or more user inputs to allow the user 402 to interact with the MR environment.

In some embodiments, the user 402 can provide a user input via the wrist-wearable device 426, an HIPD 442, the MR device 432, and/or the smart textile-based garments 438 that causes an action in a corresponding MR environment. In some embodiments, each device uses respective sensor data and/or image data to detect the user input and provide an accurate representation of the user 402’s motion. While four different input devices are shown (e.g., a wrist-wearable device 426, an MR device 432, an HIPD 442, and a smart textile-based garment 438) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 438) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user’s experience within the MR environment. Although not shown, the smart textile-based garments 438 can be used in conjunction with an MR device and/or an HIPD 442.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a separate set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 4A-4C-2 provided above are intended to augment the description provided in reference to FIGS. 1A, 1B, and 2. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method, comprising:
at an illumination system for performing eye-tracking at an augmented reality (AR) device, the illumination system comprising (i) one or more laser sources, (ii) one or more waveguides, (iii) one or more phase-tuning elements, and (iv) a plurality of emission apertures including a first emission aperture and a second emission aperture:
causing emission, via a respective laser source of the one or more laser sources, of laser light;
receiving, via the one or more waveguides, the laser light from the respective laser source, such that the laser light is propagated along a first optical path and a second optical path;
adjusting, via a respective phase-tuning element of the one or more phase-tuning elements, the phase in the first optical path, such that a respective phase in the first optical path is different than another respective phase in the second optical path;
outputting, via at least the first and second emission apertures, respective laser light from the first and second optical paths, to form a fringe illumination pattern; and
based on the fringe illumination pattern formed by the respective laser light from the first and second optical paths, determining an orientation of a user’s pupil.

2. The method of claim 1, wherein:
the one or more laser sources comprises a first laser source and a second laser source,
the one or more waveguides includes a first waveguide configured to receive first light from the first laser source, and a second waveguide configured to receive second light from the second laser source, and
each of the first waveguide and the second waveguide are coupled to a different respective phase-tuning element, including the respective phase-tuning element and another phase-tuning element that is distinct and separate from the respective phase-tuning element.

3. The method of claim 2, wherein the first laser source and the second laser source are formed in a same semiconductor substrate.

4. The method of claim 3, wherein:
the same semi-conductor substrate includes a cladding layer, an active region, and a top layer,
each of the first and second laser sources are embedded into separate locations of the top layer of the same semi-conductor substrate,
the first laser source is coupled to a first gain-tuning element, and a first phase-tuning element, and
the second laser source is coupled to a second gain-tuning element separate from the first gain-tuning element and a second phase-tuning element separate from the first phase-tuning element, such that the second laser source is independently tunable in both gain and phase from the first laser source.

5. The method of claim 4, wherein at least one of the first waveguide and the second waveguide are configured to adjust at least one other parameter of the first and second laser sources besides phase or gain.

6. The method of claim 1, wherein:
the one or more waveguides includes a first optical waveguide that is optically split to form the first optical path and the second optical path, and
only one of the first and second optical paths of the first optical waveguide is coupled with the respective phase-tuning element.

7. The method of claim 6, wherein a period of fringes in the fringe illumination pattern is defined by a distance between the first optical path and the second optical path of the first optical waveguide.

8. The method of claim 1, wherein the phase tuning element includes at least one of a thermo-optical modulator, one or more free carrier depletion based base shifters, or liquid crystals.

9. An illumination system for performing eye-tracking at an AR device, the illumination system comprising:
one or more laser sources;
one or more waveguides;
one or more phase-tuning elements;
a plurality of emission apertures including a first emission aperture and a second emission aperture;
one or more processors; and
memory, comprising instructions that, when executed by the one or more processors, cause operations for:
causing emission, via a respective laser source of the one or more laser sources, of laser light;
receiving, via the one or more waveguides, the laser light from the respective laser source, such that the laser light is propagated along a first optical path and a second optical path;
adjusting, via a respective phase-tuning element of the one or more phase-tuning elements, the phase in the first optical path, such that a respective phase in the first optical path is different than another respective phase in the second optical path;
outputting, via at least the first and second emission apertures, respective laser light from the first and second optical paths, to form a fringe illumination pattern; and
based on the fringe illumination pattern formed by the respective laser light from the first and second optical paths, determining an orientation of a user’s pupil.

10. The illumination system of claim 9, wherein:
the one or more laser sources comprises a first laser source and a second laser source,
the one or more waveguides includes a first waveguide configured to receive first light from the first laser source, and a second waveguide configured to receive second light from the second laser source, and
each of the first waveguide and the second waveguide are coupled to a different respective phase-tuning element, including the respective phase-tuning element and another phase-tuning element that is distinct and separate from the respective phase-tuning element.

11. The illumination system of claim 10, wherein the first laser source and the second laser source are formed in a same semiconductor substrate.

12. The illumination system of claim 11, wherein:
the same semi-conductor substrate includes a cladding layer, an active region, and a top layer,
each of the first and second laser sources are embedded into separate locations of the top layer of the same semi-conductor substrate,
the first laser source is coupled to a first gain-tuning element, and a first phase-tuning element,
the second laser source is coupled to a second gain-tuning element separate from the first gain-tuning element and a second phase-tuning element separate from the first phase-tuning element, such that the second laser source is independently tunable in both gain and phase from the first laser source.

13. The illumination system of claim 9, wherein:
the one or more waveguides includes a first optical waveguide that is optically split to form the first optical path and the second optical path, and
only one of the first and second optical paths of the first optical waveguide is coupled with the respective phase-tuning element.

14. The illumination system of claim 13, wherein a period of fringes in the fringe illumination pattern is defined by a distance between the first optical path and the second optical path of the first optical waveguide.

15. A non-transitory, computer-readable storage medium comprising instructions that, when executed by one or more processors of an AR device, cause operations comprising:
at an illumination system for performing eye-tracking at an AR device, the illumination system comprising (i) one or more laser sources, (ii) one or more waveguides, (iii) one or more phase-tuning elements, and (iv) a plurality of emission apertures including a first emission aperture and a second emission aperture:
causing emission, via a respective laser source of the one or more laser sources, of laser light;
receiving, via the one or more waveguides, the laser light from the respective laser source, such that the laser light is propagated along a first optical path and a second optical path;
adjusting, via a respective phase-tuning element of the one or more phase-tuning elements, the phase in the first optical path, such that a respective phase in the first optical path is different than another respective phase in the second optical path;
outputting, via at least the first and second emission apertures, respective laser light from the first and second optical paths, to form a fringe illumination pattern; and
based on the fringe illumination pattern formed by the respective laser light from the first and second optical paths, determining an orientation of a user’s pupil.

16. The non-transitory, computer-readable storage medium of claim 15, wherein:
the one or more laser sources comprises a first laser source and a second laser source,
the one or more waveguides includes a first waveguide configured to receive first light from the first laser source, and a second waveguide configured to receive second light from the second laser source, and
each of the first waveguide and the second waveguide are coupled to a different respective phase-tuning element, including the respective phase-tuning element and another phase-tuning element that is distinct and separate from the respective phase-tuning element.

17. The non-transitory, computer-readable storage medium of claim 16, wherein the first laser source and the second laser source are formed in a same semiconductor substrate.

18. The non-transitory, computer-readable storage medium of claim 17, wherein:
the same semi-conductor substrate includes a cladding layer, an active region, and a top layer,
each of the first and second laser sources are embedded into separate locations of the top layer of the same semi-conductor substrate,
the first laser source is coupled to a first gain-tuning element, and a first phase-tuning element,
the second laser source is coupled to a second gain-tuning element separate from the first gain-tuning element and a second phase-tuning element separate from the first phase-tuning element, such that the second laser source is independently tunable in both gain and phase from the first laser source.

19. The non-transitory, computer-readable storage medium of claim 15, wherein:
the one or more waveguides includes a first optical waveguide that is optically split to form the first optical path and the second optical path, and
only one of the first and second optical paths of the first optical waveguide is coupled with the respective phase-tuning element.

20. The non-transitory, computer-readable storage medium of claim 15, wherein the phase tuning element includes at least one of a thermo-optical modulator, one or more free carrier depletion based base shifters, or liquid crystals.
